(19) United States
(12) Patent Application Publication
(10) Pub. No.: US 2004/0083792 A1
(43) Pub. Date: May 6, 2004

(54) System and method for detecting hydride gases at low concentrations and in the presence of varying humidity levels

(76) Inventor: Elena Nikolskaya, St. Petersburg (RU)

Correspondence Address: ATMI, INC., 7 COMMERCE DRIVE, DANBURY, CT, 06810, US

(21) Appl. No.: 10/285,147

(22) Filed: Oct. 31, 2002

(51) Int. Cl. G01N 27/00; G01N 7/00

(52) U.S. Cl. 73/31.05; 73/23.2

(57) ABSTRACT

The present invention provides a method and system for detecting low levels of arsine in the presence of varying humidity levels. The present invention incorporates a moisture filter that absorbs and desorbs water as humidity levels change onto an arsine detector. This moisture filter may take the form of a solid tablet formed of a porous, hydrophilic material with a series of small holes therein. The walls of the holes absorb and desorb water as the humidity changes while permitting arsine to pass through unobstructed. Since the electrochemical current responds to the change in the water but the oxidation of arsines responds to the absolute concentration, the effect is that the signal to noise ration is improved by the presence of the moisture filter.

### FIELD OF THE INVENTION

The present invention relates to hydride gas sensors, which have high sensitivity to hydrides but low sensitivity to varying humidity levels in air. This property is critical for providing sufficiently high signal to noise ratio (S/N). If a hydride sensor responds strongly to both, a false positive signal can arise due to the humidity change. More specifically, the present invention provides a system and method for detecting low levels of arsine (ArH₃) in the presence of varying humidity levels.

### BACKGROUND OF THE INVENTION

Electrochemical sensors have been used for many years to detect arsine. Current sensors have insignificant change in their zero current i₀ at constant humidity. However, under the conditions of changing water concentration, there is a change in the of the sensor. This change in i₀ can be interpreted as a hydride challenge.

At the Threshold Limit Value (TLV) of 50 ppb by volume, the S/N ratio is sufficiently high, and it is unlikely for the conventional electrochemical sensors to produce false alarm due to changes in humidity level in the surrounding environment. However, the government is planning to push the TLV down to 3 ppb, which requires that the current noise term be about 17 times lower, in order to compensate for the lower signal and to keep the S/N ratio at sufficiently high level for preventing occurrence of false alarm.

The challenges come from the fact that the electrical current signals that are measured by the conventional electrochemical sensors can be influences by many variables other than the hydride gas concentration to be measured, which include humidity level in the surrounding environment, temperatures, and concentration of certain interfering gas species that are electrochemically active.

For example, at constant humidity level, the zero current i₀ is not strongly dependent on the humidity. However, changes in the humidity level result in reorganization of the double layers of the sensor electrode, which subsequently causes changes in the current flow. Without independent humidity measurement, the current cannot be unambiguously assigned to humidity changes, and a possible false positive will result.

It is therefore important to measure changes in the humidity level, and provide corrections for the impacts of such changes on the zero current.

However, two limiting features exist with this correction approach:

1. Existing electrochemical sensor systems do not usually provide means for measuring the ambient humidity level, much less means for correcting the impacts of such changes on the output signals.

2. The rates of response of the electrochemical sensor and the independent humidity sensor are different, which results in response mismatch between the two sensors. The difference between these two sensors can give rise to a false positive signal.

### SUMMARY OF THE INVENTION

The present invention therefore provides a hydride sensor that substantially eliminates or reduces the above limitations of the conventional electrochemical hydride sensors.

More specifically, the present invention provides a method and system for detecting a target hydride gas at low concentration levels and in the presence of varying humidity levels, by incorporating a moisture filter onto a hydride detector for absorbing and desorbing moisture as humidity level changes.

One aspect of the present invention relates to a hydride sensor system comprising:

a housing;

a hydride sensing element disposed in such housing for detecting presence of a target hydride gas; and

an output element communicatively connected to the hydride sensing element for providing an output signal when the hydride sensing element detects the presence of the target hydride gas,

wherein the housing comprises a moisture filter.

Such moisture filter preferably comprises a solid material that is hydrophilic, porous, and/or having a sorption affinity for moisture that is higher than that for the target hydride gas. More preferably, such solid material has a sorption affinity for moisture at least twice higher, or ten times higher, or a hundred times higher, than that for the target hydride gas. In such manner, the moisture filter effectively removes moisture without significantly affecting the sensitivity of such hydride sensor system with respect to the target hydride gas.

Such moisture filter may be formed of drying gels having a globular structure, such as silica gel, alumina gel, aerogel, metal oxide, or any like materials suitable for absorbing moisture without significantly reducing sensitivity to the target hydride gas.

Such moisture filter may take any suitable conformation, such as tablets, plates, disks, nets, domes, spheres, semi-spheres, ellipsoids, polyhedrons, etc. In a preferred embodiment of the present invention, such moisture filter takes the form of a tablet having one or more small holes therein, while such tablet comprises a solid hydrophilic material having a higher sorption affinity for moisture than that for a specific hydride gas, such as arsine. The walls of the small holes in such tablet absorb and desorb moisture as the humidity level changes, while permitting hydride gas such as arsine to pass through unobstructed. Since the electrical current signal responds to changes in the humidity level, but the oxidation of arsine responds to changes in the arsine concentration, the signal to noise ratio is therefore improved by using such moisture filter.

Accordingly, it is an object of the present invention to provide a sensor system that has a high hydride gas sensitivity (given the low concentration challenge) and a significantly reduced response to changes in the humidity level. The sensor system of the present invention has a sufficiently high S/N ratio at the lower arsine concentrations, i.e., below 10 ppb by volume, more preferably below 5 ppb by volume, and most preferably below 2 ppb by volume. Preferably, such sensor system is equipped with additional electronic devices to accommedate any changes in the electronic algorithms.

Moreover, since the temperature changes likely result in changes in the zero current (i₀) of the hydride sensor system of the present invention, it is also desirable to measure such temperature changes, by using an independent temperature sensor (e.g., thermistor, resistance temperature detector, etc.), and then to mathematically correct the impact of such temperature changes on the output signal. Such correction can be conducted by any computational means, which include, but are not limited to, computers, central processing units (CPU), microprocessors, integrated circuitries, computational modules, or the like, which is constructed, operated and arranged to correct the output signals of the electrochemical sensors based on the temperature changes measured. The computational means may be embodied in any suitable form, such as software operable in a general-purpose programmable digital computer, or available on-line as an operational applet at an Internet site. Alternatively, the computational means may comprise electronic algorithms hard-wired in circuitry of a microelectronic computational module, embodied as firmware.

Other objects and advantages of the present invention will be more fully apparent from the ensuing disclosure and appended claims.

### BRIEF DESCRIPTION OF THE DRAWINGS

FIG. 1 is a schematic view of a moisture filter in form of a tablet that is attachable to a housing of an arsine sensor, according to one embodiment of the present invention.

FIG. 2 is a graph that plots the S/N ratio as a function of the number of holes in the moisture filter.

FIG. 3 is a graph that plots system sensitivity to arsine as a function of the hole diameter in a moisture filter having 4 holes.

FIG. 4 is a graph that plots the system response to moisture changes as a function of hole size in a moisture filter having 4 holes.

FIG. 5 is a response curve of an arsine sensor in response to to a two ppb arsine challenge.

FIG. 6 shows the response curves of two arsine sensors N2 and N3 in response to a 2 ppb arsine challenge.

FIG. 7 shows the response curve of an arsine sensor in room air, with and without a fan blowing on the sensor system (1.22 pa/bit on the vertical axis).

FIG. 8 shows a graph plotting the output signal from an arsine sensor, as a function of the number of 0.9 mm holes in the moisture filter, while relative humidity changes from 10% to 50%.

FIG. 9 shows the current output from two arsine sensors (N23.4 and N2) in response to temperature changes.

FIG. 10 is a graph depicting the effect of temperature changes on the zero signal output of the N23.4 and N2 arsine sensors.

FIG. 11 depicts the sensitivity of the arsine sensor to arsine gas, as a function of the number of 0.9 mm holes provided in the moisture filter.

FIG. 12 is a graph showing the concentration dependence of the sensitivity of three arsine sensors (N23.4, N2, and N6) with respect to arsine gas.

### DETAILED DESCRIPTION OF THE INVENTION

The present invention provides a hydride gas sensor with a high S/N ratio. This has been achieved by placing a moisture filter, which in one embodiment is a solid tablet made of hydrophilic material and having small holes drilled in the tablet, on the housing of such sensor. The function of such tablet with holes is to provide surface to absorb moisture and, thereby, buffer the rate of change of the moisture concentration in the electrochemical sensor.

The tablet of the moisture′ filter in one embodiment comprises one or more hydrophilic and porous materials, either artificial or natural. Such materials preferably include, but are not limited to, drying gels having a globular structure, such as silica gel, alumina gel, aerogel, or metal oxides, or any like materials as known to those skilled in the art.

This moisture filter must have a sorption affinity for moisture that is much higher than that for the hydride of interest, i.e., twice higher, ten times higher, or a hundred times higher. Therefore, such filter will effectively remove moisture without reducing the sensitivity of the hydride sensor to the hydride of interest.

Use of damping resistors in the circuit may further reduce the high frequency noise of the hydride sensor.

The signal can be integrated over an interval time (usually ≧2 minutes) that is longer than the conventional 30 seconds, to further smooth out the signal. Various electronic filtering methods can also be used.

An electrical hardware damper in the form of a series resistor may also be used to eliminate high frequency noises.

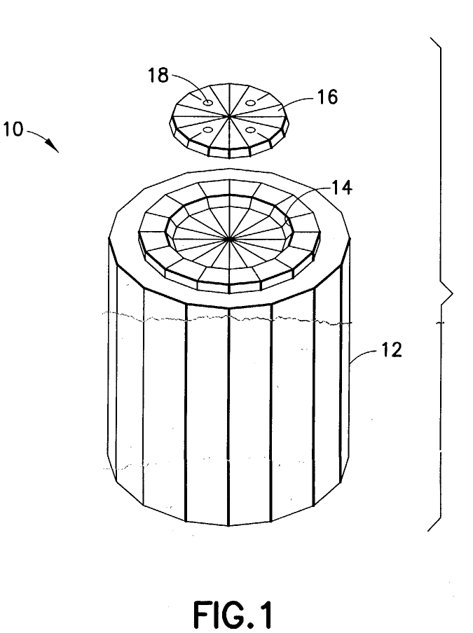

FIG. 1 shows an arsine sensor 10 with a cylindrical housing 12. The upper side of such cylindrical housing 12 comprises an opening 14, to which a moisture filter 16 comprising silica gel can be fixed. The moisture filter 16 is shaped like a tablet or a disk, having four holes 18 therein, each hole having a diameter of about 0.9 mm. The diameter of such moisture filter 16 is about 13 mm. Inside the housing 12 are disposed an arsine sensing element (not shown) that is capable of detecting presence of arsine gas at a sufficiently low concentration (i.e., below 50 ppb, or 10 ppb, or 5 ppb), and an output element (not shown) for providing an output signal when the presence of arsine gas is detected.

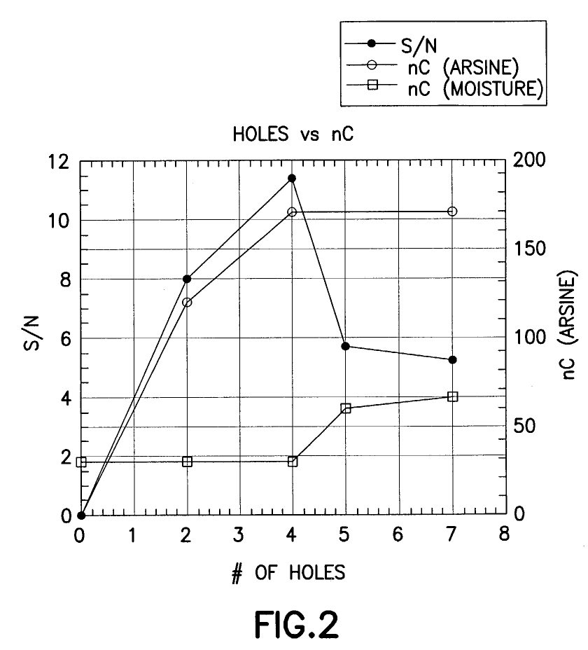

FIG. 2 depicts the signal to noise ratio of the arsine signal and the moisture signal, as a function of holes within the moisture filter. As seen in FIG. 2, a peak is observed with a 4-hole configuration. At this peak, the S/N ratio of arsine at 2 ppb is 11. For purpose of practicing the present invention, any number of holes ranging from about to about 10 is acceptable, although such number is preferably within a range of from about 2 to about 5.

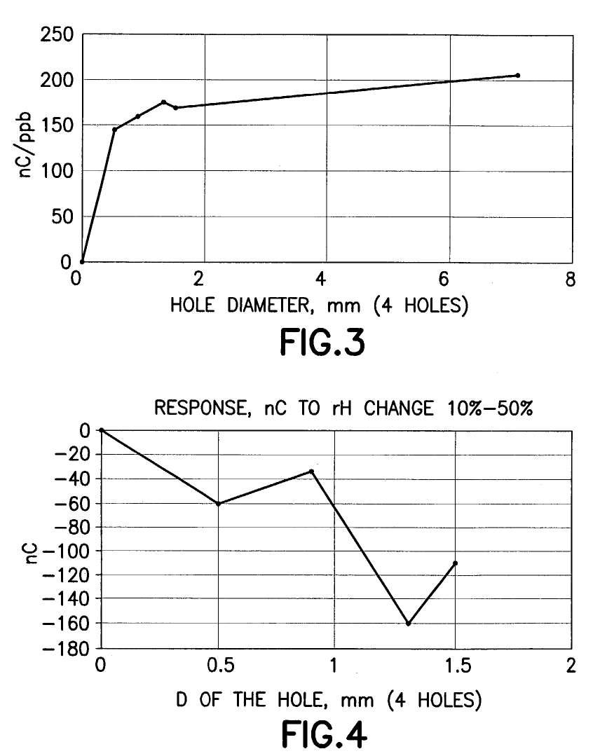

FIG. 3 shows the sensitivity of the arsine sensor of the present invention to arsine as a function of hole size, provided that the number of holes is 4. The sensitivity reaches a sufficiently high level when the hole diameter is above about 0.2 mm, and the sensitivity shows a plateau when the hole diameter is about 1 mm. Further increasing hole size must be balanced against sensitivity to humidity.

FIG. 4 shows the moisture response of the arsine sensor as a function of hole size, provided that the number of holes is 4.

From the data provided in FIGS. 3 and 4, a 4-hole moisture filter can be designed to maximize the arsine sensitivity while minimizing the moisture interference, by optimizing the hole diameter. Preferably, the holes have an average diameter of from about 0.2 mm to about 1.1 mm, more preferably from about 0.45 mm to about 0.975 mm, and most preferably about 0.9 mm.

Since the diameter of the moisture filter used herein is about 13 mm, it is desirable to use a 4-hole moisture filter having holes of an average diameter that is about 1.5%-8.5% of the overall diameter of the moisture filter. More preferably, the holes have an average diameter that is about 3.5% to about 7.5% of the overall diameter of the moisture filter, and most preferably about 7% thereof.

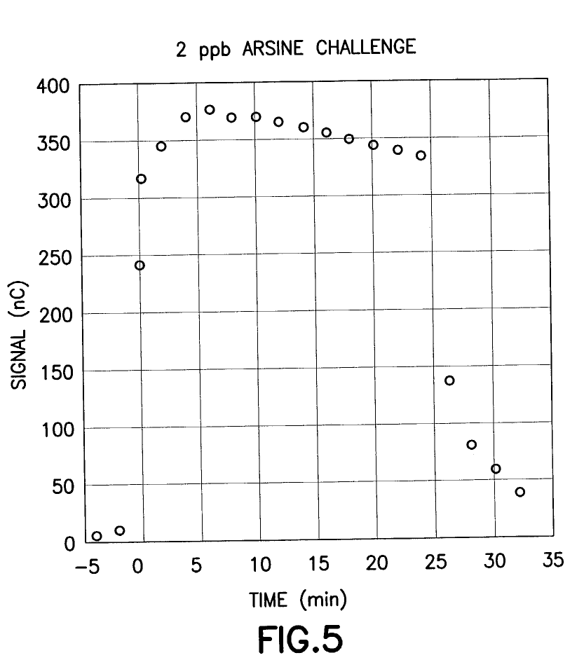

FIG. 5 is the response curve of an arsine sensor to a two ppb challenge, which shows the response time (too) of such arsine sensor, which is defined as the time taken by the output signal from the buffered sensor to change from 10% of the final value to 90% of the final value in response to a step change in the arsine concentration. The response time (too) for the sensor is in the range of 2-3 minutes.

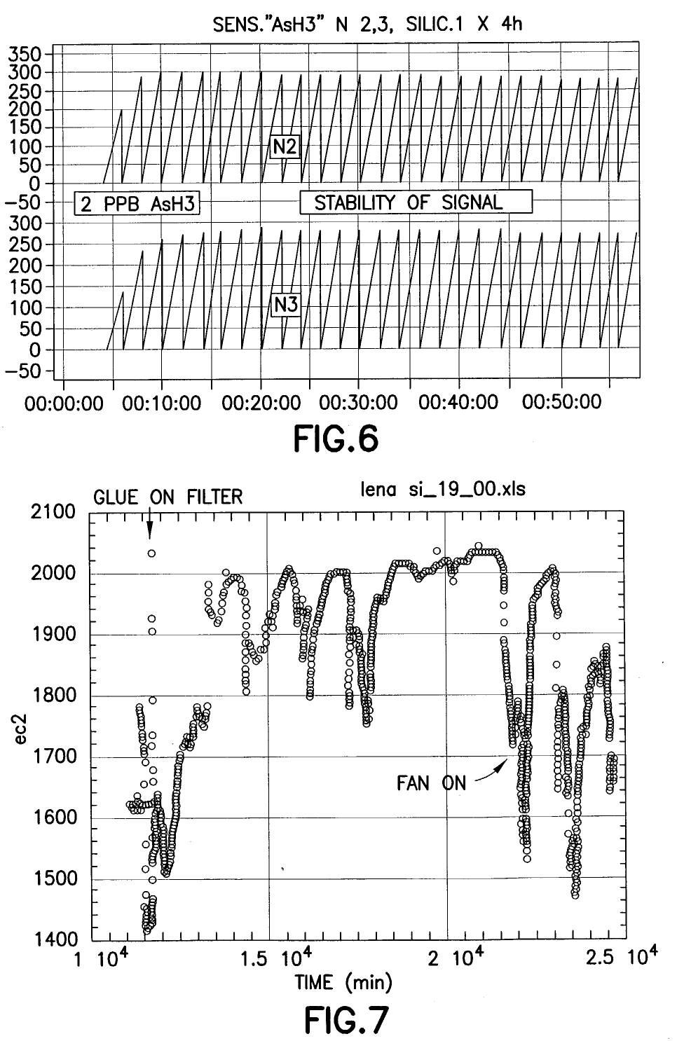

FIG. 6 shows the response curves of two arsine sensors N2 and N3 to a 2 ppb arsine challenge, which evidence the stability and reproducibility of the measurement results as obtained by using the arsine sensors of the present invention.

FIG. 7 shows the stability of an arsine sensor in room air with and without a fan blowing on the sensor system (1.22 pA/bit on the vertical axis).

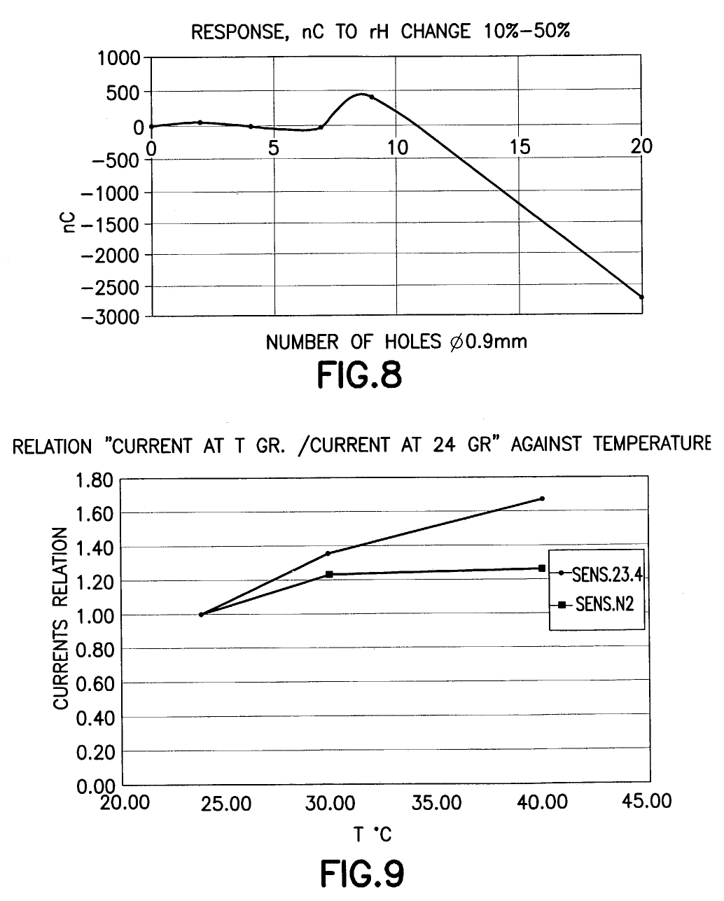

FIG. 8 shows a graph plotting the output signal from an arsine sensor, as a function of the number of 0.9 mm holes in the moisture filter, while relative humidity changes from 10% to 50%. When the number of 0.9 mm holes is above 10, the output signal is significantly influenced by the changes in humidity levels, giving rise to a false positive signal.

FIG. 9 shows the current output from two arsine sensors (N23.4 and N2) in response to temperature changes.

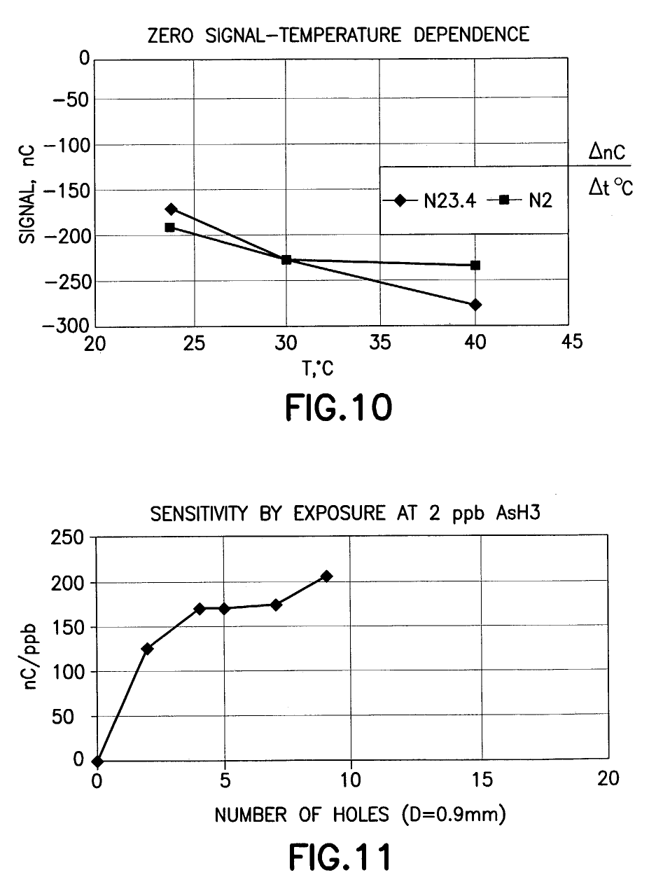

FIG. 10 is a graph depicting the effect of temperature changes on the zero signal output of the N23.4 and N2 arsine sensors.

In order to compensate for the temperature fluctuations in the arsine sensors, which gives rise to larger error rates in the measurement results, it is desirable to provide an independent temperature sensing element to determine the temperature changes, and then mathematically correct the influence of such temperature changes on the measurement results by using a computational means, as described hereinabove.

FIG. 11 depicts the sensitivity of an arsine sensor to arsine gas, as a function of the number of 0.9 mm holes provided in the moisture filter.

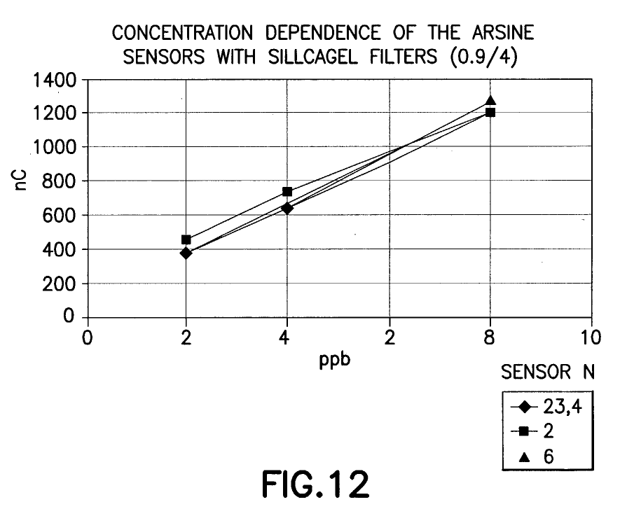

FIG. 12 is a graph showing the concentration dependence of the sensitivity of three arsine sensors (N23.4, N2, and N6) with respect to arsine gas.

It is desirable that the hydride sensor of the present invention has a large measuring range, i.e., from about 1 ppb to about 100 ppb, more preferably from 1 ppb to about 50 ppb, while the lower detection limit (LDL) of such hydride sensor is sufficiently low for detecting the target hydride gas at very low concentration. For example, such hydride sensor may have a LDL of less than 10 ppb, preferably less than 5 ppb, more preferably less than 3 ppb, and most preferably about 1 ppb.

Algorithms may also be used in the electronic software to provide high frequency damping of the signal noises from the signal.

Inclusion of a large resistor in the lead to the counter electrode increases the RC value in the impedance value. The larger RC time constant filters out some of the high frequency noise and lowers the noise in the system.

Increasing opening in the face of the electrochemical sensor from 7 mm to 10 mm increases the sensitivity without increasing the noise term significantly.

Digital or analog integration removes the high frequency noise from the system. Digital (software) integration of filtering is desirable since no printed circuit board level changes need to be made to the system. The existing hardware with a software change can be used at the lower arsine level.

While the invention described herein with reference to specific aspects, features, and embodiments, it will be apparent that other variations, modifications, and embodiments are possible, and all such variations, modifications, and embodiments therefore are to be regarded as being within the spirit and scope of the invention.

Although the present invention has been described in detail, it should be understood that various changes substitutions and alterations could be made hereto without departing from the spirit and scope of the invention.

What is claimed is:

1. A hydride sensor system comprising:
a housing;
a hydride sensing element disposed in said housing for detecting presence of a target hydride gas; and
an output element communicatively connected to said hydride sensing element for providing an output signal when said hydride sensing element detects the presence of the target hydride gas,
wherein said housing comprises a moisture filter.

2. The hydride sensor system of claim 1, wherein said moisture filter comprises a solid material that is hydrophilic.

3. The hydride sensor system of claim 1, wherein said moisture filter comprises a solid material that is porous and hydrophilic.

4. The hydride sensor system of claim 1, wherein said moisture filter comprises a solid material having a sorption affinity for moisture that is higher than that for the target hydride gas.

5. The hydride sensor system of claim 4, wherein said solid material has a sorption affinity for moisture that is at least twice higher than that for the target hydride gas.

6. The hydride sensor system of claim 4, wherein said solid material has a sorption affinity for moisture that is at least ten times higher than that for the target hydride gas.

7. The hydride sensor system of claim 4, wherein said solid material has a sorption affinity for moisture that is at least a hundred times higher than that for the target hydride gas.

8. The hydride sensor system of claim 1, wherein said moisture filter comprises one or more drying gels having a globular structure.

9. The hydride sensor system of claim 1, wherein said moisture filter comprises at least one material selected from the group consisting of silica gels, alumina gels, aerogels, and metal oxides.

10. The hydride sensor system of claim 1, wherein said moisture filter has a conformation selected from the group consisting of tablets, plates, disks, nets, domes, spheres, semi-spheres, ellipsoids, and polyhedrons.

11. The hydride sensor system of claim 1, wherein said moisture filter has a tablet conformation.

12. The hydride sensor system of claim 11, wherein said moisture filter has one or more holes therein.

13. The hydride sensor system of claim 11, wherein said moisture filter has a number of holes in a range of from about 2 to about 10.

14. The hydride sensor system of claim 11, wherein said moisture filter has a number of holes in a range of from about 2 to about 5.

15. The hydride sensor system of claim 11, wherein said moisture filter has about four holes therein.

16. The hydride sensor system of claim 15, wherein said holes have an average diameter in a range of from about 1.5% to about 8.5% of that of a diameter of the moisture filter.

17. The hydride sensor system of claim 15, wherein said holes have an average diameter in a range of from about 3.5% to about 7.5% of that of a diameter of the moisture filter.

18. The hydride sensor system of claim 15, wherein said holes have an average diameter of about 7% of that of a diameter of the moisture filter.

19. The hydride sensor system of claim 15, wherein said holes have an average diameter in a range of from about 0.2 mm to about 1.1 mm.

20. The hydride sensor system of claim 15, wherein said holes have an average diameter in a range of from about 0.45 mm to about 0.975 mm.

21. The hydride sensor system of claim 15, wherein said holes have an average diameter of about 0.9 mm.

22. The hydride sensor system of claim 1, wherein said hydride sensing element detects presence of arsine gas.

23. The hydride sensor system of claim 1, having a measuring range from about 1 ppb to about 100 ppb.

24. The hydride sensor system of claim 1, having a measure range from about 1 ppb to about 50 ppb.

25. The hydride sensor system of claim 1, having a lower detection limit of less than about 10 ppb.

26. The hydride sensor system of claim 1, having a lower detection limit of less than 5 ppb.

27. The hydride sensor system of claim 1, having a lower detection limit of less than 3 ppb.

28. The hydride sensor system of claim 1, having a lower detection limit of about 1 ppb.

29. The hydride sensor system of claim 1, further comprising:
a temperature sensing element for measuring temperature fluctuations in proximity to said hydride sensing element; and
a computational element connected to both the temperature sensing element and the output element for correcting impact of temperature fluctuations on said output signal provided by said output element.

30. The hydride sensor system of claim 29, wherein said temperature sensing element is selected from the group consisting of thermistors and resistance temperature sensors.

31. The hydride sensor system of claim 29, wherein said computational element comprises an electronic computational device or a digital computational device.

32. The hydride sensor system of claim 1, further comprising a damping resistor for reducing high frequency noise from the output signal.

33. The hydride sensor system of claim 32, wherein said damping resistor comprises a series resistor.

34. The hydride sensor system of claim 1, further comprising a digital computational device for mathematically removing high frequency noise from the output signal.

35. A method for detecting presence of a target hydride gas in a surrounding, comprising the steps of providing a hydride sensing element disposed in a housing that has a moisture filter thereon, detecting presence of the target hydride gas using such hydride sensing element, and providing an output signal when presence of the target hydride gas is detected, wherein said moisture filter removes moisture to reduce signal to noise ratio of such hydride sensing element.
